(19) United States
(12) Patent Application Publication
(10) Pub. No.: US 2024/0318658 A1
(43) Pub. Date: Sep. 26, 2024

(54) Lightweight Hydraulics Design for Improved 3D Printability

(71) Applicant: KSB SE & Co. KGaA, Frankenthal (DE)

(72) Inventors: Boris JANJIC, Frankenthal (DE); Sebastain LANG, Frankenthal (DE)

(21) Appl. No.: 18/578,765

(22) PCT Filed: Jul. 13, 2022
(86) PCT No.: PCT/EP2022/069556

§ 371 Date: Jan. 12, 2024

(30) Foreign Application Priority Data
Jul. 15, 2021 (DE) 10 2021 118 384.7

(51) Int. Cl. F04D 29/22; F04D 1/00

(52) U.S. Cl. CPC F04D 29/2294; F04D 1/00

(57) ABSTRACT

A centrifugal pump includes a blade arrangement. The blade arrangement has a carrier unit on which blades are arranged. The blade arrangement also has cell units that enclose cavities, the cell units being formed by walls.

### CROSS REFERENCE TO RELATED APPLICATION

This application claims priority under 35 U.S.C. § 119 from German Patent Application No. 10 2021 118 384.7, filed Jul. 15, 2021, the entire disclosure of which is herein expressly incorporated by reference.

### BACKGROUND

The disclosure relates to a centrifugal pump having a blade arrangement, wherein the blade arrangement has a carrier unit on which blades are arranged.

The central constituent part of a centrifugal pump is the impeller. An impeller is a rotating component, which carries blades, of a turbomachine, for example of a centrifugal pump. In this case, mechanical power is converted into delivery power by flow deflection at the blades.

Depending on the profile of the flow lines in the impeller, the impellers may be categorized in a variety of impeller types, for example radial impeller, semiaxial impeller, axial impeller and peripheral impeller.

In order to accommodate the blades, all impellers have a carrier disk and, in the case of closed impellers, also a cover disk. If the front or outer cover disk is absent from an impeller, the impeller is considered to be open.

Because of their particular geometry, closed impellers for pumps could essentially be produced only by primary forming, in particular by the casting method. Primary forming is a principal group of manufacturing methods, in which a solid body that has a geometrically defined shape is produced from a shapeless substance. Primary forming is used to produce the initial shape of a solid body and provide the material cohesion.

The casting of metals and alloys is a manufacturing method in which workpieces are produced from liquid metal. In the die casting method, a mold is filled with the melt which subsequently solidifies therein. The inner face of the mold is the negative of the outer face of the cast article.

DE 10 2015 212 203 A1 describes such an impeller consisting of a metallic casting. The blades are in this case arranged in bundles that are produced with a particularly abrasion-resistant metal casting in a special casting mold.

Although this method can lead to smaller defects in or on the surface of the material as well as to minor geometrical deviations, the quality of the surface condition is subject to limitations too. This may impair the performance of the impeller, so that finishing operations such as comprehensive balancing or a surface treatment are sometimes necessary. Furthermore, cast impellers have a large mass and may behave sluggishly during use in pumps.

DE 10 2016 205 976 A1 describes a lightweight, non-sluggish impeller consisting of aluminum. Metals such as aluminum, which are preferentially used in lightweight construction, have advantages over cast impellers in respect of inertia but are usually not commensurately resistant to abrasion and corrosion.

The material plastic often offers corrosion-resistant properties and at the same time is not sluggish in terms of operating behavior. DE 10 2014 226 525 A1 describes an impeller consisting of a lightweight polymer matrix. In comparison with cast materials, however, plastics are substantially softer and less resistant to abrasion.

### SUMMARY

One object of the disclosure is to provide a centrifugal pump having a blade arrangement, which is resistant to abrasion as well as corrosion while at the same time not having a sluggish operating behavior. The blade arrangement is intended here to be producible simply, economically and rapidly. The blade arrangement is furthermore intended to be particularly lightweight and nevertheless have optimal flow contours.

This and other objects are achieved according to the disclosure by a centrifugal pump having a blade arrangement and a method for the production thereof. Preferred variants may be found in the description and the drawings.

According to the disclosure, the blade arrangement has cell units that enclose cavities. These cell units are formed by abrasion-resistant and corrosion-resistant walls.

A blade arrangement in the context of the disclosure is preferably configured as an impeller or as a conducting device.

Cell units are elements, or segments, of a pattern of two-dimensionally arranged cavities enclosed by bounding walls. Advantageously, the cell units are arranged without gaps between them and in this case have a favorable ratio of wall material to volume. The cell units are outstandingly suitable for lightweight designs which are at the same time configured with a view to stabilization. A cell unit, or a segment, is a part of a whole and the assembly, in particular the building together, of segments or cell units therefore provides an entire blade arrangement.

A cavity is a mathematical, physical or technical object that has a volume. A volume enclosed in a structure, for example by cell units, may be a cavity. The existence of cavities in this case often modifies the underlying structure in respect of strength, mass and resilience.

According to the disclosure, the cell units are arranged directly next to one another so that a blade arrangement having a high strength is formed without gaps. This is advantageous in particular since abrasive fluids are not offered a surface of attack on interrupted walls and/or gaps of cell units.

Ideally, cell units arranged directly next to one another share walls. This leads to a particularly stable and at the same time extremely lightweight configuration of a blade arrangement.

A wall in the context of the disclosure refers to a two-dimensional construction that delimits a cavity. By a flow-optimized arrangement in combination with a design-optimized arrangement of walls, an extremely stable blade arrangement is achieved, which is configured optimally in respect of the flow contour while being reduced to a minimum in terms of mass. The configuration of the blade arrangement therefore saves on a maximum amount of material in comparison with conventional blade arrangements which are produced by casting.

Preferably, the cell units form a honeycomb structure of the blade arrangement. The honeycomb compartments may in this case have a round, angular and/or trapezoidal configuration. They are arranged directly next to one another and may ideally be configured according to the results of a flow and design optimization. The honeycomb structure forms the basis of the blade arrangement configured as a lightweight design.

Advantageously, the walls of the cell units fully enclose the cavities. The blade arrangement configured in this way preferably has no openly accessible cavities that could negatively influence a fluid flow and the inertial behavior of the blade arrangement. The flow contour of the blade arrangement for centrifugal pumps is thereby optimally configured.

In an alternative variant of the disclosure, not all walls of the cell units fully enclose the cavities. Particularly in the case of diffusing devices, preferably in the case of diffusers, this is advantageous for the formation of flow-guiding and/or flow-diffusing cell units so that the efficiency of the centrifugal pump overall is advantageously influenced.

Preferably, all walls of the cell units are formed integrally by the carrier unit and the blades, as well as optionally by the cover disk. The integrality is achieved by a generative manufacturing method, so that walls, which enclose cavities, can be formed particularly rapidly and precisely.

In a further variant of the disclosure, the walls of the cell units, the carrier unit and the cover disk are configured in multiple pieces. In such an alternative embodiment, the walls of the cell units of the blades are applied generatively on a conventionally manufactured carrier disk. In this way, individually arranged and designed blades may be printed on a carrier disk produced by mass production, and particular customer-specific requirements may be taken into account. Because of the lightweight design of the blades, the inertia of the overall impeller occurs much less than in the case of entirely solidly configured impellers.

In one variant of the disclosure, all walls of the cell units are formed in multiple pieces and/or in a hybrid fashion by the carrier unit and the blades.

The blade arrangement, in a lightweight design consisting of cell units, is produced according to the disclosure by a generative manufacturing method. The term generative manufacturing method covers all manufacturing methods in which material is applied layer-by-layer and three-dimensional components, in particular impellers and/or a diffusing device, are thereby produced. In this case, the layerwise construction is carried out under computer control from one or more liquid or solid materials according to predefined dimensions and shapes. During the construction, physical or chemical curing or melting processes take place. Typical materials for “3D printing” are plastics, synthetic resins, ceramics, metals, carbon materials and graphite materials.

According to the disclosure, the blade arrangement for a centrifugal pump is formed by generative manufacturing. For the formation of the cell units and walls of the blade arrangement, in particular selective laser melting and cladding, also referred to as deposit welding, are employed. In an alternative variant of the disclosure, cold-gas spraying and extrusion in combination with the application of fusible plastic is also a method that may be used.

In deposit welding or cladding, the cell units of the blade arrangement are produced by a method which coats a basic structure by welding. Deposit welding in this case builds up a volume by a welding filler material in the form of a wire or a powder, which produces a particularly intricate and flow-optimized shape of the blade arrangement.

In selective laser melting, the metallic construction material in powder form is applied in a thin layer onto a plate. The material in powder form is locally melted fully by means of radiation at the respectively desired locations, and after solidification forms a solid material layer. This base plate is subsequently lowered by the extent of one layer thickness and powder is again applied. This cycle is repeated until all the layers have been fused. Excess powder is cleaned off from the finished blade arrangement.

For example, a laser beam which generates the blade arrangement from the individual powder layers may be used as radiation. The data for guiding the laser beam are produced on the basis of a 3D CAD body by means of software. As an alternative to selective laser melting, an electron beam (EBM) may also be used.

In a particularly advantageous variant of the disclosure, the fluid contact face of the blade arrangement is produced from a construction material by successive melting and solidification of layers by means of radiation. The different properties of the regions of a cell unit are in this case generated by variations of the radiation. By deliberate control of the local introduction of heat, a modification of the material properties is carried out already during the construction of the blade arrangement. This is done by producing zones and structures with different material states of a chemically homogeneous material and therefore of different properties in a region of the walls and of the cell units.

In one variant of the disclosure, the blade arrangement may be formed from different construction material. The construction material preferably comprises metallic powder particles, in particular low-alloy and/or high-alloy steel powder particles and/or fusible plastic and/or a metal-polymer hybrid material.

Preferably, the construction material for the production of the fluid contact face, in particular of the flow contour of the blade arrangement, is metallic powder particles. In one variant of the disclosure, powder particles containing iron and/or containing cobalt are used for this purpose. These may contain additives, for example chromium, molybdenum or nickel. The blade arrangement is therefore configured to be particularly abrasion-resistant and corrosion-resistant.

According to the disclosure, the cell units of the blade arrangement are formed in an additive manufacturing method. The 3D shape of the walls and of the cell units are stored in software as a data set. Tools of different additive methods may act at the locations where the walls are intended to be formed, and additively construct layer-by-layer. Advantageously, the appropriate construction process for each construction material may be carried out successively or simultaneously for each layer so that a complex blade arrangement consisting of different materials is formed, the cell units of which are adapted optimally and also individually to the requirements of subsequent use.

In one variant of the disclosure, the honeycomb structure is produced by a molten-layer tool of the additive manufacturing method, with which an array of points is applied onto a surface from fusible plastic. By extrusion by means of a nozzle and subsequent curing by cooling at the desired position, a load-bearing structure is produced, particularly in the form of cell units and/or in the form of a honeycomb structure. By the supporting region of a blade arrangement being produced so as to form cavities with a particularly load-bearing structure, a blade arrangement has an enormous strength together with a very low mass. The construction of a blade arrangement is conventionally carried out by repeatedly scanning a working plane respectively row-by-row and then displacing the working plane upward to form a stack, so that the supporting region of a blade arrangement is formed.

According to the disclosure, the walls have a thickness of less than 3 mm, preferably less than 2 mm, in particular less than 1 mm. Advantageously, the walls are configured to be particularly thin so that the effect of the lightweight design is further reinforced.

In order to achieve a particularly stable blade arrangement with the lowest possible mass, reinforcing ribs are arranged inside the cell units and/or between neighboring cell units. Ideally, the walls may be configured to be particularly thin and the blade arrangement may be configured to be as light as possible, the stability being optimally produced by exactly placed reinforcing ribs.

Preferably, the cell units, in particular of the carrier disk and the cover disk, are aligned radially and/or in the circumferential direction. This type of arrangement and alignment assists the reduction of the number of walls, so that the impeller or the diffusing device may be configured to be particularly lightweight.

According to the disclosure, the outer walls of the cell units form the fluid contact face of the blade arrangement. They are optimally adapted to the requirements for use by a CFD simulation and may be produced individually as well as rapidly by generative manufacturing.

Advantageously, the walls and/or the reinforcing ribs are produced from a metallic material, which may comprise alloy constituents so that a lightweight blade arrangement having particularly abrasion-resistant and corrosion-resistant properties may be formed. Alternatively, plastics or ceramic materials may also be used.

In one variant of the disclosure, the walls and/or the reinforcing ribs are produced from a material combination, and therefore formed as a hybrid material. In an alternative variant of the disclosure, the cavities of the cell units are filled with a filler. Preferably, the filler is configured as a lightweight plastic so that the stability of the blade arrangement is increased and at the same time the mass of the blade arrangement remains low.

According to the disclosure, the blade arrangement, which is configured as an impeller, may comprise a cover disk that is formed from cell units. These cell units consist of walls that enclose cavities. Advantageously, the entire impeller is therefore configured as a lightweight design so that the impeller has an enormous stability with a very low mass.

Ideally, because of the lightweight design of the blade arrangement, the so-called printing time of the additive manufacturing is extremely short. The generative production of the blade arrangement is therefore of particularly economical interest and significantly more competitive in comparison with production by means of casting.

Furthermore, the individual configuration of the blade geometry, of the flow contour and of the arrangement of the reinforcing ribs is particularly advantageous. In contrast to a cast impeller, finishing in order to adapt to customer-specific requirements or a system-specific adaptation to the blade arrangement do not need to be carried out. The blade arrangement may be designed in a way which is optimized for the intended use and manufactured individually without entailing the costs for an individual casting mold, including elaborate finishing.

According to the disclosure, stocking of a multiplicity of impellers or diffusing devices may preferably be obviated. The existing design data of an impeller or of a diffusing device may be used on demand for direct generative re-manufacture, so that the indirect costs of stocking are avoided.

Ideally, because of the lightweight design of a blade arrangement consisting of cell units, a prototype of interest may be produced in an extremely short period of time and tested in test systems. The development time of new impellers or diffusing devices may therefore advantageously be shortened.

According to the disclosure, the blade arrangement in lightweight design may be used for applications in which lightweight and non-sluggish blade arrangements open up entirely new prospects for use. The blade arrangement according to the disclosure is preferably suitable for use in flow pumps for microdosing applications.

Further features and advantages of the disclosure may be found in the description of exemplary embodiments with the aid of the drawings and in the drawings themselves, in which:

### BRIEF DESCRIPTION OF THE DRAWINGS

FIG. 1 shows a central section of the blade arrangement according to the disclosure,

FIG. 2 shows a sectional representation of the blades, and

FIG. 3 shows a representation of the cross-sectional area of a carrier unit.

### DETAILED DESCRIPTION

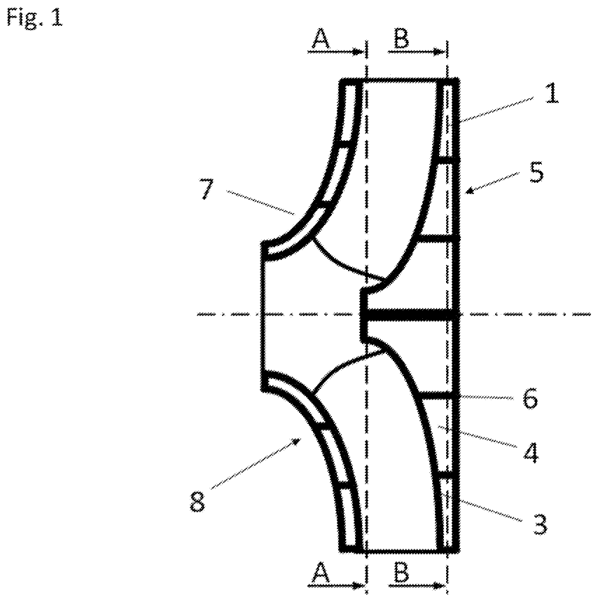

FIG. 1 represents a central section through the blade arrangement 8 according to the disclosure, which in this exemplary embodiment is configured as an impeller. The carrier unit 1 and the cover disk 7 have cell units 5 that enclose cavities 4. The cell units 5 are formed by walls 3, on some of which reinforcing ribs 6 are arranged.

In this exemplary embodiment, the walls 3 are produced generatively from corrosion-resistant alloy particles, which are configured in a modified way by means of energy input by radiation. The surfaces of the impeller are therefore configured to be particularly abrasion-resistant. The impeller is constructed entirely from cell units 5 in the form of cavity segments. The impeller is therefore particularly lightweight and non-sluggish in terms of operating behavior.

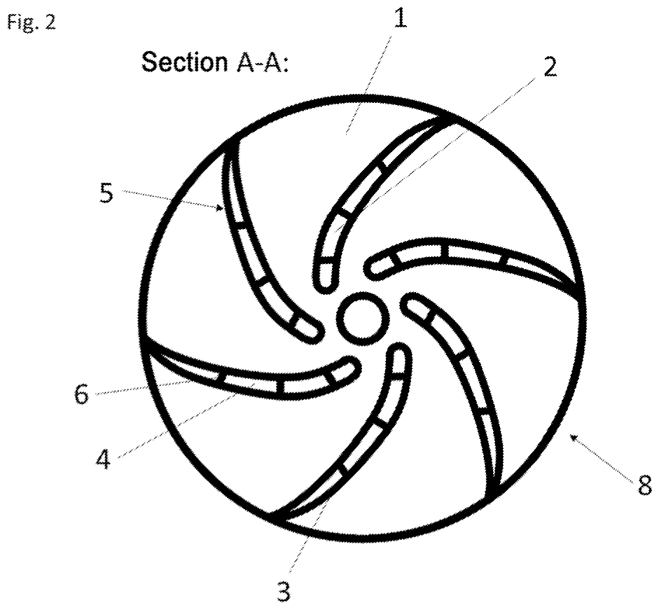

FIG. 2 shows a section of the blades 2 of the blade arrangement 8, which in this exemplary embodiment is configured as an impeller. The blades 2 have cell units 5 that enclose cavities 4. The cell units 5 are formed by walls 3. At particularly stressed locations of the impeller, reinforcing ribs 6 are arranged on the walls 3. The walls 3 of the blades 2 are in this exemplary embodiment configured to be particularly flow-optimized and have a thickness of less than 3 mm, preferably less than 2 mm, in particular less than 1 mm. The impeller with the blades 2 is therefore configured to be particularly lightweight. Neighboring cell units 5 in this case share walls 3, so that the walls 3 of the blades 2 and the carrier unit 1 are configured integrally overall.

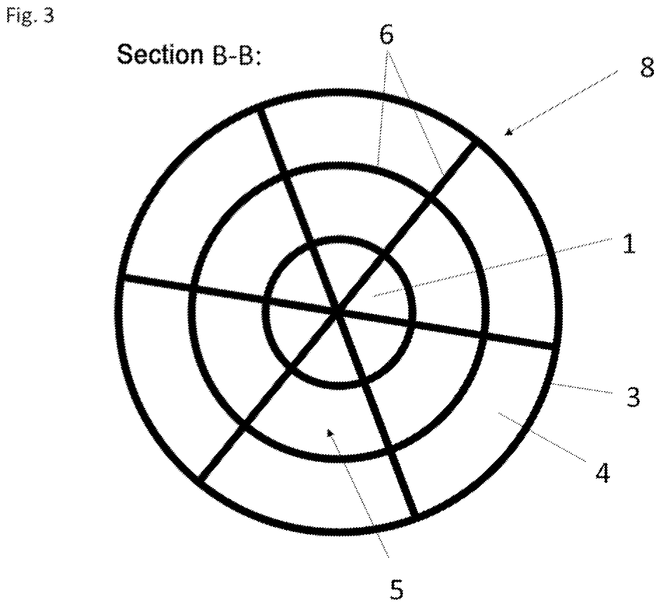

FIG. 3 represents a section of the carrier unit 1 of a blade arrangement 8. The carrier unit 1 has cell units 5 that enclose cavities 4. The cell units 5 are formed from walls 3, on some of which reinforcing ribs 6 are arranged. The cell units 5 are in this case aligned radially and in the circumferential direction.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1.-18. (canceled)

19. A centrifugal pump comprises:
a blade arrangement, wherein
the blade arrangement has a carrier unit on which blades are arranged, and
the blade arrangement has cell units that enclose cavities, the cell units being formed by walls.

20. The centrifugal pump as claimed in claim 19, wherein cell units are arranged directly next to one another.

21. The centrifugal pump as claimed in claim 20, wherein the cell units arranged directly next to one another share walls.

22. The centrifugal pump as claimed in claim 21, wherein the cell units form a honeycomb structure.

23. The centrifugal pump as claimed in claim 22, wherein the walls of the cell units fully enclose the cavities.

24. The centrifugal pump as claimed in claim 21, wherein the walls of the cell units have open cavities.

25. The centrifugal pump as claimed in claim 24, wherein the walls of the cell units are formed integrally by the carrier unit and blades.

26. The centrifugal pump as claimed in claim 24, wherein all of the walls of the cell units are formed in multiple pieces and/or in a hybrid fashion by the carrier unit and blades.

27. The centrifugal pump as claimed in claim 26, wherein the walls have a thickness of less than 3 mm.

28. The centrifugal pump as claimed in claim 27, further comprising reinforcing ribs that are arranged inside the cell units and/or between neighboring cell units.

29. The centrifugal pump as claimed in claim 28, wherein the cell units are aligned radially and/or in the circumferential direction.

30. The centrifugal pump as claimed in claim 29, wherein the walls of the cell units form the fluid contact face of the blade arrangement.

31. The centrifugal pump as claimed in claim 30, wherein the walls and/or the reinforcing ribs are produced from a metallic material.

32. The centrifugal pump as claimed in claim 30, wherein the walls and/or the reinforcing ribs are produced from a material combination.

33. The centrifugal pump as claimed in claim 32, wherein the cavities of the cell units are at least partially filled with a material.

34. The centrifugal pump as claimed in claim 33, wherein the blade arrangement further comprises a cover disk that has cell units with cavities, which are enclosed by walls.

35. A method for producing a centrifugal pump having a blade arrangement as claimed in claim 34, with an integrative manufacturing unit, the method comprising:
forming the cell units from a construction material;
configuring the walls and/or the reinforcing ribs by selective action of energy in the form of radiation, temperature and pressure,
producing the walls and the reinforcing ribs by deliberate variation of the action of energy, and
deliberate variating of the thickness of the walls in order to adapt to the load requirements.

36. The use of a centrifugal pump having a blade arrangement as claimed in claim 34 as a microdosing pump.
